(19) United States
(12) Patent Application Publication
(10) Pub. No.: US 2011/0188666 A1
(43) Pub. Date: Aug. 4, 2011

(54) METHOD AND SYSTEM FOR PREVENTING OVERHEARING OF PRIVATE CONVERSATIONS IN PUBLIC PLACES

(75) Inventors: Jonathan David Mason, Eindhoven (NL); Jan Van Evert, Eindhoven (NL); Gerardus Bullens, Tilburg (NL)

(73) Assignee: KONINKLIJKE PHILIPS ELECTRONICS N.V., EINDHOVEN (NL)

(21) Appl. No.: 13/054,514

(22) PCT Filed: Jul. 10, 2009
(86) PCT No.: PCT/IB2009/052996

§ 371 Date: Apr. 1, 2011

(30) Foreign Application Priority Data
Jul. 18, 2008 (EP) 08160716.0

(51) Int. Cl. H04R 3/02

(52) U.S. Cl. 381/73.1

(57) ABSTRACT

A method for preventing overhearing of private conversations in public spaces is disclosed. The method comprises detecting the social activity of the people in the public space and assessing the social situation and adapting the degree of sound masking and/or sound absorption at the desired locations to suit the assessed social situation. The method can be useful in public environments such as airports, city centers, club, bars, cafes and shopping centers where it is required to prevent over-hearing of private conversations.

### FIELD OF THE INVENTION

The present subject matter relates to a method for preventing overhearing of private conversations in public places and more specifically for preventing overhearing of private conversations in a hotel lobby environment.

### BACKGROUND OF THE INVENTION

US patent 2003/0026436 discloses an apparatus for acoustically improving an environment. In an embodiment, an electronic sound screening system comprises means for receiving acoustic energy and converting it into electrical signals, means for performing an analysis of said electrical signals and for generating data analysis signals, means responsive to the data analysis signals for producing signals representing sound, and output means for converting the sound signals into sound.

The solution disclosed in US2003/0026436 may not be suited for a dynamic environment where conversations are not constant and the sound generated changes significantly at various locations within the public space.

Hence it would be advantageous to have an improved method and system for preventing overhearing of private conversations in public places.

### SUMMARY OF THE INVENTION

Accordingly, the present subject matter preferably seeks to mitigate, alleviate or eliminate one or more of the above mentioned disadvantages singly or in combination. In particular, it may be seen as an object of the present subject matter to provide an improved method and system for preventing overhearing of private conversations in public places.

This object and several other objects are obtained in a first aspect of the present subject matter by providing a method for preventing overhearing of private conversations in public places, the method comprising
detecting the social activity of the people in the public space and assessing the social situation; and
adapting the degree of sound masking and/or sound absorption at the desired locations to suit the assessed social situation.

The present subject matter discloses solution for supporting and enhancing social interactions between people in public spaces for example in a hotel lobby environment. The hotel lobby is an environment where business and leisure guests meet for different purposes and thus so do their different social situations. The hotel lobby can be described as a dynamic environment and the noise made by guests in the surroundings may change dramatically throughout the day and in different locations within the lobby.

As an illustrative example, business guests often hold impromptu meetings in the lobby prior to withdrawing to a presentation or conference, whereas leisure guests may sit and read the newspaper or wait for other members of their party to arrive. In these situations these guests may not wish to be overheard by others or do not want to disturb others sitting near them. These guests also might need a more quiet environment, where for e.g. background music volume is limited.

The idea of the invention is to continuously and anonymously detect social activity, interpret the collected data to determine the level of sound masking via subtle alterations in the music or by physical sound barriers.

The method disclosed in the present patent application provides a solution to overcome these problems by providing a sound masking and/or sound absorbing solution which automatically adapts its properties locally to the social situation.

The disclosed solution to mask and/or block the sound does not operate as being ON/OFF. The disclosed solution takes into account the social interactions happening among the people and how the social interactions change. The social interactions can be dynamic and can keep changing resulting in different social situations. The disclosed solution takes into account these changing social situations. The disclosed solution does not mask and/or block the entire public space. The disclosed solution detects the social situations and assesses the social situation. Based on the assessed social situation the degree of sound masking and/or sound absorption is adapted at the desired locations to suit the assessed social situation. Hence, the disclosed solution uses sound masking and/or sound absorption solution at locations where it is required. The disclosed solution has the advantage that it can adapt itself to the changing social situation.

The disclosed solution links sound masking technique with the detection of social situations and as a result the degree of sound masking and/or absorption is altered automatically to suit the social situation.

In an embodiment, adapting the degree of sound masking comprises altering the background audio by performing one of the following tasks:

i) addition of percussion or bass of the background audio at the desired location

ii) deletion of percussion or bass of the background audio at the desired location

iii) addition of different audio channels to the background audio

Different channels contain different elements, such as for e.g. percussion and bass. Bass consists of low frequency tones in music. Percussion and bass are only a few categories that can enable a harmonic ensemble of music. More elements can be used to create a good sounding music stream.

Overhearing of private conversations can be prevented using the principles of sound masking but unlike sound masking techniques that use a single bass sound (white or pink noise) the disclosed solution can alter the background audio by adding or removing aspects of percussion or bass at the desired locations. The idea here is to create a harmonic ensemble of background music. The guests only can notice the effects of the system but may not actively note the system itself working.

Sound masking here refers to the method of reducing the perception of undesired sounds or unpleasant noises. Sound masking can use natural or artificial sound that can hide the unpleasant ones. As an illustrative example, sound masking can be achieved by generating the noise of running water which can effectively block other sounds such as conversations. The channels that are around the running water frequencies are important. However to create a harmonic ensemble, more channels may be needed.

The disclosed embodiment provides a solution by locally masking private conversations with other sounds in such a way, that the systems are automatically activated when the social situations require it.

This embodiment discloses social situation dependant local sound masking with audio. The background audio that is played for example in the hotel lobby is altered in particular locations. The background audio can be altered by reducing or increasing its volume and by altering its composition. The audio system can create its own stream of music by combining pre-composed music channels.

In a further embodiment, adapting the degree of sound absorption comprises activating a physical sound screen at the desired location. The physical sound screens are not permanently activated (i.e. on). Based on the assessed social situation the physical sound screens can be activated. There is no need for the group of people to move the physical sound screens around the lobby if they wish to hold a private conversation. Hence, the people involved in the private conversation are not disturbed. Further, visual blocking can also be a quality of the physical sound screen.

In this embodiment, the detection of the social situation is coupled to the operation of physical sound screens which can change shape, move or alter their sound absorbing parameters to suit the social situation. In other words, this embodiment provides sound absorbing solution which automatically adapts its properties locally to the social situation.

This embodiment discloses social situation dependant local sound blocking with physical sound screens. As an illustrative example, let us consider the following scenario:
i) a group (of say about 3-4 people) has been detected
ii) the social situation assessed indicates that the group is involved in a private conversation
iii) an individual has been detected close to the group
   In such a scenario, a decision can be made to activate the physical sound screen between the detected group and the individual who can overhear the private conversation of the group. Like the audio system, the physical sound screen also does not have an ON/OFF. It is permanently able to alter itself to the social situation at hand. This physical sound screen can block/prevent the sound getting transmitted from the group to the individual.

The physical sound screen can be adapted automatically based on the detection of the social situation and hence can be an intelligent sound screen. The ongoing conversation may not be affected since there is no need for the people involved in the private conversation to move the physical sound screen. Hence, the people involved in the private conversation are not disturbed.

Activating the physical sound screen can involve a mechanical movement for example turning some shutters to make a barrier or altering the number or size of holes in the physical sound screen. In general, the physical sound screen can be any device that can block or prevent sound transmission.

This embodiment provides sound absorbing solution which automatically adapts its properties locally to the social situation.

In a still further embodiment, the method can be used for preventing overhearing of private conversations in a hotel lobby environment where business and leisure guests meet together.

The hotel lobby is an environment where business and leisure guests meet for different purposes and thus so do their different social situations. For example, business guests often hold impromptu meetings in the lobby prior to withdrawing to a presentation or conference, whereas leisure guests may sit and read the newspaper or wait for other members of their party to arrive. In these situations, these guests may not wish to be overheard by others or do not want to disturb others sitting near them. The guests also might need a more quiet environment, where for e.g. background music volume is limited. The disclosed solution can be advantageous in such social situations and can prevent overhearing of private conversations.

In a second aspect of the present subject matter, a system for preventing overhearing of private conversations in public spaces is disclosed. The system comprises:
a plurality of sensors that can be attached to any physical entity present in the public space;
a processing unit configured to process the inputs from the plurality of sensors and detect the social activity of the people and assess the social situation; and
an adaptation unit configured to adapt the degree of sound masking and/or sound absorption at the desired locations to suit the assessed social situation.

In an embodiment of the system, the sensor can be one of the following:
pressure sensor
proximity sensor
camera
position sensor
microphone.

### BRIEF DESCRIPTION OF THE DRAWINGS

These and other aspects, features and advantages will be further explained by the following description, by way of example only, with reference to the accompanying drawings, in which same reference numerals indicate same or similar parts, and in which:

FIG. 1 schematically illustrates an exemplary embodiment of social situation dependant local sound masking with music; and

FIG. 2 schematically illustrates an exemplary embodiment of social dependant local sound blocking with physical sound screens.

### DETAILED DESCRIPTION OF THE EMBODIMENTS

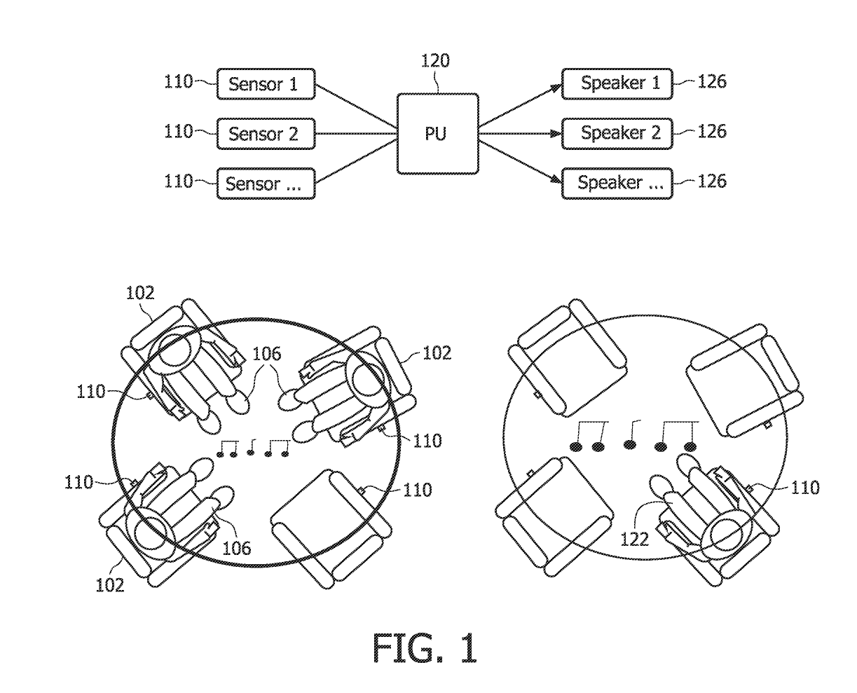

Referring now to FIG. 1, the hotel lobby environment comprises

i. physical entities 102 (e.g. furniture, sign boards, cup boards, cabinets, tables, wall panels, large panels of rigid material mounted under or into the ceiling or floor) around the hotel lobby environment
ii. people 106 having private conversations in groups
iii. a plurality of sensors 110 attached to the physical entities present in the hotel lobby environment
iv. a processing unit 120
v. a plurality of speakers 126
The sensors can be used to detect the social situation that take place among the people in the hotel lobby environment. The sensors could be one of (not limited to)
i. pressure sensors that could be attached to the legs of the chairs to detect the presence of a sitting person
ii. cameras to detect the positions of the people
iii. proximity sensors to detect how close or far objects (or people) are from each other
iv. position sensors to detect who is facing who
v. microphones to detect the noise generated.

It is also possible to use ultra-sound array sensing to identify the location of people without the need to attach sensors to physical objects such as chairs or tables. The ultra sound sensor for e.g. can be attached to the ceiling.

In general, sensors can be used to i) detect the proximity among people ii) detect the posture (e.g. whether they are sitting down) iii) find out people who are facing each other from which it is possible to detect which people belong to the same group iv) orientation and posture can be detected that can be used to find out the level of intimacy of the conversation v) additional information such as time of the day and location in the hotel lobby environment can also be sensed. The idea is to use one or a combination of different sensors to detect the social situation in the public space.

The processing unit 120 is configured to monitor all the inputs from the sensors and assess the social situation. Actual recording of sound may not be permitted in many public places. In such situations, the invention can be practiced without the microphones. Different levels of interaction can be detected through other sensors. Nevertheless, a microphone can also be used if permitted. Based on the assessed social situation, the processing unit can alter the background audio that is being played in the lobby accordingly. As an example, based on the social situation of the people, the audio can be dynamically adapted using different channels of the audio.

The processing unit 120 can for e.g. be a rule based system that consists of a rule base. The rule based system can compare facts about the detected social situation against a stored set of rules. When a match is made the rule can be activated. As an illustrative example, a simple rule might look like

IF Condition 1 is satisfied THEN consequence 1

IF Condition 2 is satisfied THEN consequence 2 else consequence 3.

It may also be possible to create a chaining effect with one rule enabling another rule to activate. The process can continue until there are no more rules to activate and the output can be used for adapting the degree of sound masking and/or sound absorption.

As an illustrative example, let us consider the following scenario:

i. using cameras it has been detected that four seats are occupied and the position of the seats are facing each other
ii. using cameras it has been detected that papers are spread out on the table
iii. using microphones it has been detected that the noise generated in this area is x % higher than the neighboring areas. The semantics behind the noise generated may not be recorded. It can only be the sound level (and perhaps additional information like intonation) that are needed to detect the social context.

The processing unit can make use of these inputs and assesses the social situation that the group is a business group having a business meeting or a leisure group. In case, the processing unit assesses the presence of other individuals nearby then the processing unit may decide to mask the sound from the business group or the leisure group. This can prevent disturbance to the other individuals and prevent overhearing of the business groups or leisure groups private conversation.

The camera can work as a sensor for identifying the location of people. In some situations in the context of the hotel, the camera may not be suitable due to privacy requirements. In such situations, it is possible to use ultra sound array scanning or use other sensors such as heat sensing to locate the position of people. In other words, one has to strike a balance on all possible sensors for detecting social activity taking into consideration the privacy requirements of the hotel environment.

The proposed means of sound masking differs from traditional systems which send a particular type of sound (low frequency) into the environment. In the present embodiment the background audio that is played in the entire lobby can be altered in particular locations. The audio can be altered by reducing or increasing its volume and by altering its composition (i.e. audio can be used to mask the conversations to potential over-hearers). Not only the volume, but other dynamics of the sound can be used (e.g. each of the different audio channels have unique characteristics that can allow each channel to have its own masking characteristics).

As an illustrative example, in FIG. 1 the music in the area of the left (i.e. circle marked in thick lines) can be made to decrease in volume and the lower frequency aspects of the music can be reduced. This means that the group of people within the circle marked in thick lines can hear each other clearly without the need to shout over the sound of the music and the lower frequency sounds do not mask their conversation. This can also indirectly aid in reducing the unpleasant disturbance and enhance the quality of the private conversation. The music in the area of the right (i.e. circle marked in thin lines) can be made to increase in volume and lower frequencies can be added so that the individual 122 in the circle marked in thin lines cannot hear the business or leisure group's conversation so clearly. The music in both areas can be made to change very subtly so that the individual 122 is not aware of the change. It is also possible to not only mask the sounds but also shield them by adding different music channels to it.

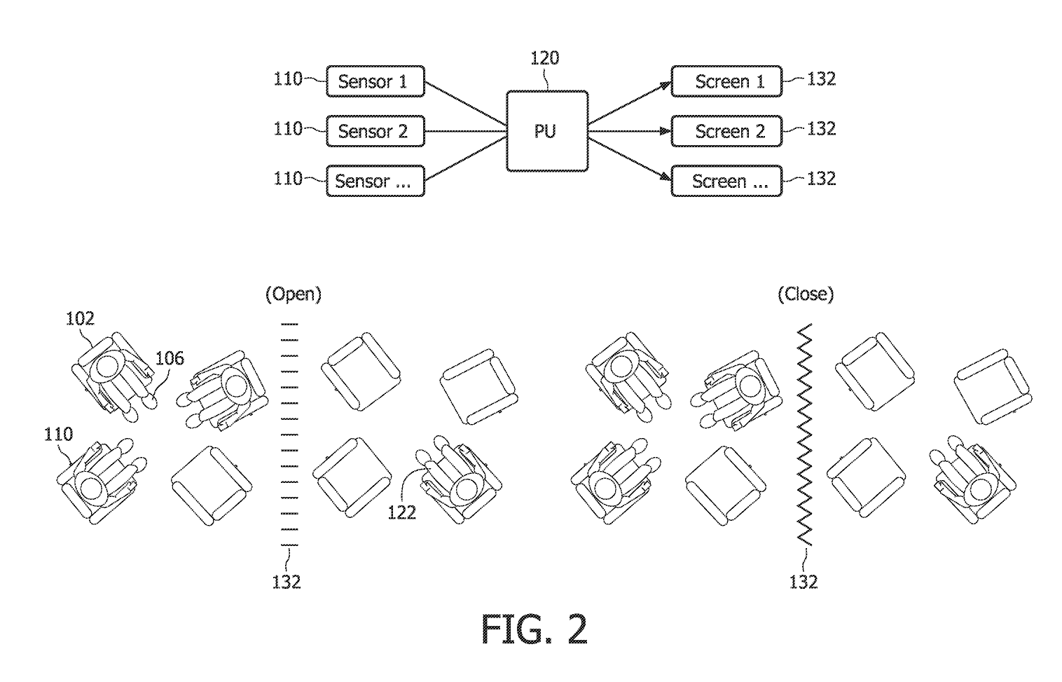

Referring now to FIG. 2, in addition to the components shown in FIG. 1, the hotel lobby environment comprises physical sound screens 132 that can be used as partitioning devices to partition the groups.

The processing unit can monitor all the inputs from the sensors and assess the social situation. Based on the assessed social situation the physical sound screen can be activated.

As an illustrative example, let us consider the following scenario:

i. a group (of say about 3-4 people) has been detected
ii. an individual has been detected close to the group
iii. the social situation assessed indicates that the group is involved in a private conversation
In such a scenario, a decision can be made to activate the physical sound screen 132 between the detected group and the individual overhearing the private conversation of the group. This physical sound screen 132 can block/prevent the sound getting transmitted from the group to the individual. Further, the physical sound screen can reduce the visibility of the group in conversation to potential over-hearers.

Activating the physical sound screen could involve a mechanical movement for example turning some shutters to make a barrier or altering the number or size of holes in the physical sound screen. In general, the physical sound screen could be any device that can block or prevent the sound transmission.

The detection of the social activity can be linked to operation of the physical sound screen which can change shape, move or alter their sound absorbing parameters to suit the social situation.

Further, it is important that these physical sound screens do not apply the decisions made by the processing unit too quickly for danger of the operation becoming too obvious; the physical sound screens ought to alter their positions and how open or closed they are throughout the day so that their movements appear to be of a random nature and not pre-programmed.

The physical sound screens can be covered with sound absorbing materials and textures to alter the sound transmission properties. The physical sound screen can contain holes or slits that can be opened or closed to allow or prevent sound transmission respectively. In an alternative embodiment, the physical sound screens can be mobile, automatically moving forward as needed.

The physical sound screen can always be active and be responsive to the social situation of the people in the public space. The physical sound screen can use the information about the social situation (e.g. spatial arrangement of the people) to interpret it.

The word ‘physical sound screen’ here is used to describe a device that can block the sound (or even vision of guests). It is noted that the physical sound screen is only one form that this invention could take. Other forms can also be designed. As an example, the physical sound screen can be a semi-transparent screen that might change its physical appearance (by moving) or its opacity (from transparent to non-transparent).

The inventors have linked sound masking techniques (audio and/or physical sound screens) in combination with the detection of social situation of the guests and as a result the degree of sound masking and/or sound absorption can be made to alter locally to suit the social situation.

Further, for illustration purposes hotel lobbies has been considered. The present subject matter can be applied to many different public environments such as airports, city centers, parks, offices, casinos, railway stations, club, bars, schools, libraries, restaurants, cafes and shopping centers where it is required to prevent overhearing of private conversations.

In general, the prior art of using the sensors, physical sound screens, actuators to move the physical sound screens, controllers and other hardware units can be consulted to provide example of how to incorporate them into the disclosed system. Such information is known to the art and is not set forth in detail.

In summary, a method for preventing overhearing of private conversations in public spaces is disclosed. The method comprises detecting the social activity of the people in the public space and assessing the social situation and adapting the degree of sound masking and/or sound absorption at desired locations to suit the assessed social situation. The method can be useful in public environments such as airports, city centers, bars, club, cafes and shopping centers where it is required to prevent overhearing of private conversations.

Although claims have been formulated in this application to particular combinations of features, it should be understood that the scope of the disclosure of the present subject matter also includes any novel features or any novel combination of features disclosed herein either explicitly or implicitly or any generalization thereof, whether or not is relates to the same subject matter as presently claimed in any claim and whether or not it mitigates any or all of the same technical problems as does the present subject matter.

Further, while the subject matter has been illustrated in detail in the drawings and foregoing description, such illustration and description are to be considered illustrative or exemplary and not restrictive; the subject matter is not limited to the disclosed embodiments. Other variations to the disclosed embodiments can be understood and effected by those skilled in the art of practicing the claimed subject matter, from a study of the drawings, the disclosure and the appended claims. As an example, the array of speakers may be incorporated in the sound screens (besides being in the furniture). A single unit may fulfill the functions of several items recited in the claims. The mere fact that certain measures are recited in mutually different dependent claims does not indicate that a combination of these measures cannot be used to advantage.

Use of the verb “comprise” and its conjugates does not exclude the presence of elements other than those stated in a claim or in the description. Use of the indefinite article “a” or “an” preceding an element or step does not exclude the presence of a plurality of such elements or steps. The figures and description are to be regarded as illustrative only and do not limit the subject matter. Any reference sign in the claims should not be construed as limiting the scope.

1. A method for preventing overhearing of private conversations in public spaces, the method comprising
detecting the social activity of the people in the public space and assessing the social situation; and
adapting the degree of sound masking and/or sound absorption at the desired locations to suit the assessed social situation.

2. The method as claimed in claim 1, wherein adapting the degree of sound masking comprises altering the background audio by performing one of the following tasks:
i) addition of percussion or bass of the background audio at the desired location
ii) deletion of percussion or bass of the background audio at the desired location
iii) addition of different audio channels to the background audio.

3. The method as claimed in claim 1, wherein adapting the degree of sound absorption comprises activating a physical sound screen at the desired location.

4. The method as claimed in claim 1, wherein the method is used for preventing overhearing of private conversations in a hotel lobby environment where business and leisure guests meet together.

5. A system for preventing overhearing of private conversations in public spaces, the system comprising:
a plurality of sensors that can be attached to any physical entity present in the public space;
a processing unit configured to process the inputs from the plurality of sensors and detect the social activity of the people and assess the social situation; and
an adaptation unit configured to adapt the degree of sound masking and/or sound absorption at the desired locations to suit the assessed social situation.

6. The system as claimed in claim 5, wherein the sensor is one of the following:
pressure sensor
proximity sensor
camera
position sensor
microphone.
